(19) United States
(12) Patent Application Publication
(10) Pub. No.: US 2015/0091823 A1
(43) Pub. Date: Apr. 2, 2015

(54) PRINTED ARTICLE

(71) Applicant: Novalia Ltd, Cambridge (GB)

(72) Inventor: Kate Stone, Cambridge (GB)

(21) Appl. No.: 14/377,724

(22) PCT Filed: Feb. 9, 2012
(86) PCT No.: PCT/GB2013/050265

§ 371 Date: Nov. 6, 2014

(30) Foreign Application Priority Data
Feb. 9, 2012 (GB) 1202299.2

(51) Int. Cl. G06F 3/041; G09G 3/06

(52) U.S. Cl. CPC G06F 3/041; G09G 3/06; G09G 2354/00; G09G 2370/025
USPC 345/173

(57) ABSTRACT

A printed article (2), such as a poster or point-of-sale display is described. The printed article comprises a substrate (21), a touch- or proximity-sensitive switch (25) supported on the substrate, a processor (26) configured to generate, in dependence upon actuation of the switch, a message (50) and a wireless interface (26, 28) configured to transmit the message wirelessly.

### FIELD OF THE INVENTION

The present invention relates to a printed article, such as a poster or point-of-sale display.

### BACKGROUND

Electronic components are increasingly being incorporated into printed articles, such as books, posters and greeting cards, to allow printed articles to become more interactive.

For example, GB 2464537 A describes a book whereby a story can be read in different ways because user input can affect the narrative and/or a different narrative can be presented to the reader each time the book is opened.

GB 2475253 A describes a poster which can be custom made and used to control a presentation on a display.

TW 2008 21976 A describes a smart electronic poster system which automatically transmits various media information, such as text, a voice message, a photo file or video files, to a client about a product.

### SUMMARY OF THE INVENTION

According to a first aspect of the present invention there is provided a printed article comprising a substrate, a touch- or proximity-sensitive switch supported on the substrate, a processor configured to generate, in dependence upon actuation of the switch, a message, and a wireless interface configured to transmit the message wirelessly, e.g. by low power Bluetooth®.

Thus, the printed article can be employed to control a mobile device and to use the mobile device as an agent for rendering content, e.g. audio, to enhance the functionality of the printed article. For example, a user can touch an image on a poster and cause the mobile device to retrieve and play an audio clip (e.g. speech and/or sound effect) corresponding to an image displayed on the poster. The audio clip may already be stored locally on the mobile device or may be stored remotely on a server. Thus, content need not be stored at or transmitted by the printed article.

Additionally or alternatively, the printed article can be employed to collect information and to transmit the information (or data generated from the information) wirelessly to a remote location.

The switch may comprise conductive ink, such as silver-, copper- or carbon-based ink. The switch may comprise conductive foil. Thus, the touch- or proximity-sensitive switch can be easily and cheaply incorporated into the printed product, for example, by printing or foil stamping.

The printed article may comprise at least two touch- or proximity-sensitive switches. Thus, the printed article can be used to provide more complex forms of control.

The substrate may comprise paper or card, and/or plastic. The substrate may comprise a laminate.

The wireless interface may be compatible with Bluetooth® and/or IEEE 802.11 (i.e. WiFi).

The printed article may comprise a poster or a point-of-sale display. The point-of-sale display may take the form of shelf edging, a dummy pack (i.e. an empty pack), a display pack, a display stack, a mobile, a poster or a banner.

The message may control a mobile application. The message may control a web browser.

The printed article may be configured to establish secure communication with a mobile device, e.g. by transmitting (and optionally receiving) encrypted or encoded signals. However, information may be transmitted unencrypted.

The message may include an article identifier identifying the printed article. The message may include at least one switch identifier, each switch identifier identifying a respective actuated switch. The same switch may be actuated more than once. The message may include information about one or more actuated switches, such as information about an order in which switches are actuated or time(s) at which switch(es) are actuated. The message may include at least one command, for example, for moving a pointer or focus on a display. The message may include at least one complex command, for example, comprising multiple commands and/or computer code, such as a script or applet. The message may include at least one content identifier, each content identifier indentifying respective content. The message may include at least one universal resource identifier (URI), such as an IP address. The URI may identify a source of content. The message may include information about content. The message may include a target identifier, for example, identifying a device to which content, computer code and/or other data is to be transmitted. The message may include a timestamp. The message may comprise more than one message.

The printed article may comprise a code visible to a user, such as a quick response (QR) code.

According to a second aspect of the present invention there is provided a system comprising a printed article and a device which is in wireless communication with the printed article.

The device is preferably connected to another network.

The device may be a mobile device, such as smart phone, tablet computer or other form of hand-held device. The device may comprise a wireless access node.

The device may be configured, in response to receiving a message from the printed article, to retrieve content from an external source, such as a server, or to transmit data to an external source, such as a server.

The device may be configured, in response to an initial message transmitted by the printed article, to retrieve settings for interpreting further messages transmitted by the printed article in response to actuation of switch(es). The initial message may comprise an identifier (e.g. a name) and/or an address (e.g. a media access control address). The device may comprise an application for responding to the message and to retrieve the settings. The system may further comprise a server storing the settings.

The system may further comprise a server for providing content to the mobile device. Thus, content need not be stored at or transmitted by the printed article. The mobile device may be capable of storing and/or retrieving, and then playing a large volume of data.

The content may include audio content, for example, speech, music or sound effect. The content may include image content, such as a picture or photo, and/or video content.

According to a third aspect of the present invention there is provided a mobile device which is configured, in response to receiving an initial message from a printed article, the initial message including an identifier identifying the printed article or an application related to the printed article, to retrieve information (or “settings”) from a remote server for interpreting further message(s) from the printed article. The device may be configured, in response to receiving a further message from the printed article, the further message including an identifier for identifying a switch, to cause the device to respond to the further message in dependence on the information (or settings).

The mobile device may comprise an application which is configured, in response to receiving the initial message, to retrieve the information (or settings) from the remote server. The application may be configured, in response to receiving the further message, to cause the device to respond to the further message in dependence on the information (or settings).

The device may receive more than one further message.

According to a fourth aspect of the present invention there is provided a method comprising a device wirelessly receiving an initial message from a printed article, the initial message including an identifier identifying the printed article or an application related to the printed article, and using the identifier to retrieve information (or settings”) for interpreting further message(s) from the printed article.

Thus, the device can be paired with a printed article, retrieve settings and then interpret further messages received from printed article.

The device may retrieve the information from a remote server.

The printed article comprises a substrate, a touch- or proximity-sensitive switch supported on the substrate, a processor configured to generate, in dependence upon actuation of the switch, a message, and a wireless interface configured to transmit the message wirelessly. The method may comprise the printed article transmitting the initial message, for example in response to actuation of the switch for a first time or for a first time within a given time period. This can be used to pair a printed article and the device and to allow the device to retrieve settings.

The printed article may comprise a plurality of touch- or proximity-sensitive switches supported on the substrate. The method may comprise the printed article transmitting a further message in response to actuation of a switch, the message including an identifier for identifying the switch.

According to a fifth aspect of the present invention there is provided a unit housing at least one electronic component which is configured to be clamped to a printed article.

The unit may comprise clamping members supporting a set of at least one conductive pad on an inner clamping surface connected to the at least one electronic component.

According to a sixth aspect of the present invention there is provided an assembly comprising a printed article supporting a set of at least one conductive pad and a unit housing at least one electronic component clamped to a printed article over the at least one conductive pad.

### BRIEF DESCRIPTION OF THE DRAWINGS

Certain embodiments of the present invention will now be described, by way of example, with reference to the accompanying drawings in which:

FIG. 1 illustrates a system including a printed article which is capable of receiving user input and wirelessly communicating with another device;

FIG. 2 is a block diagram of a microcontroller included in the printed article shown in FIG. 1;

FIG. 3 is a block diagram of the mobile device shown in FIG. 1;

FIG. 4 illustrates a printed article transmitting a message to another device;

FIG. 4a illustrates the message shown in FIG. 4;

FIG. 5 illustrates a printed article transmitting a message to a mobile device;

FIG. 6 is a block diagram showing flow of data between the printed article and mobile device shown in FIG. 5;

FIG. 7 illustrates a printed article transmitting a message to a mobile device and the mobile device retrieving content;

FIG. 8 is a block diagram showing flow of data between the printed article, the mobile device and server shown in FIG. 7;

FIG. 9 illustrates a printed article transmitting a message to a mobile device, the mobile device retrieving content and forwarding the content to the printed article;

FIG. 10 is a block diagram showing flow of data between the printed article, the mobile device and server shown in FIG. 9;

FIG. 11 illustrates a printed article transmitting a message to a mobile device or routing node, the mobile device or routing node requesting content and a server forwarding the content to another device;

FIG. 12 is a block diagram showing flow of data between the printed article, the mobile device or routing node, the server and the other device shown in FIG. 11;

FIG. 13 is a block diagram showing flow of data between one or more printed articles, a logging node and a server;

FIG. 14 is a block diagram showing flow of data between a printed article, a mobile device and a server;

FIG. 15 is a back view illustrating a unit which can be clamped to a printed article;

FIGS. 16 and 17 are side views illustrating the unit in FIG. 15 when clamped and unclamped respectively.

### DETAILED DESCRIPTION OF CERTAIN EMBODIMENTS

### Wireless System 1

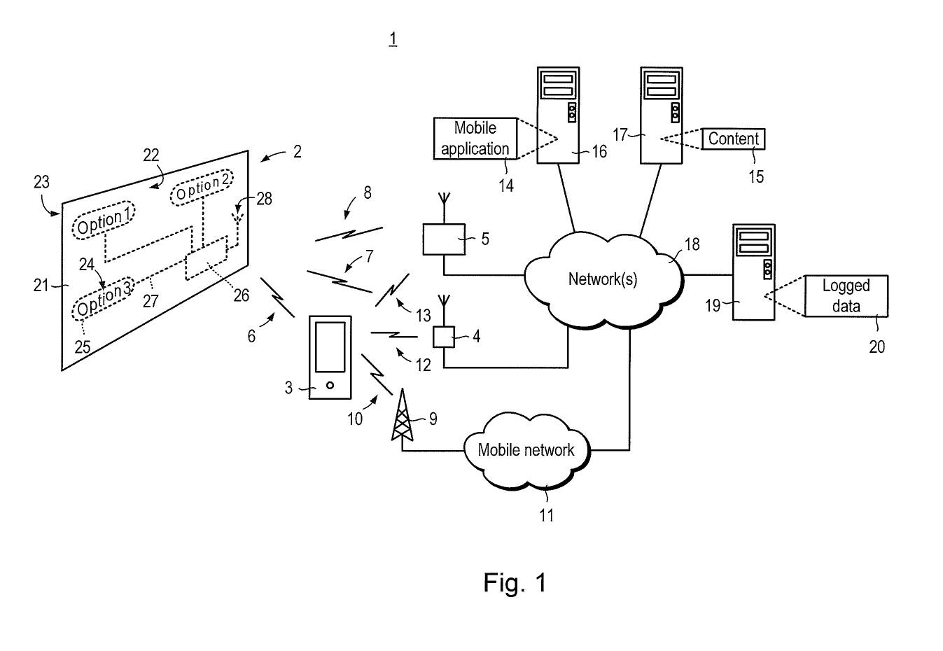

Referring to FIG. 1, a wireless system 1 is shown.

The wireless system 1 comprises at least one printed article 2 and at least one other device 3, 4, 5. The or each printed article 2 (hereinafter only one printed article 2 is referred to) is capable of receiving user input, for example through capacitive touch sensing, and wirelessly communicating with a devices 3, 4, 5 via respective wireless links 6, 7, 8. The printed article 2 preferably communicates using a low-power, short-range (<100 m) wireless communications technology, such as low-power (v4.0) Bluetooth.

The at least one other device 3, 4, 5 may include a mobile device 3, a routing node 4 and/or a logging node 5.

The mobile device 3 is capable of wirelessly communicating with a base station 9 via a mobile communications link 10. The base station 9 is connected to a mobile communications network 11. The mobile device 3 may also be capable of wirelessly communicating with the routing node 4 via a wireless link 12 and/or with the logging node 4 via a wireless link 13.

The mobile device 3 can download a mobile application 14 (colloquially often referred to as an “app”) and content 15 from first and second servers 16, 17 respectively via the routing node 4 and one or more networks 18.

The logging node 5 can communicate with a third server 19 via the one or more networks 18 to store logged data 20.

Other servers (e.g. web servers) are connected to the network 18.

### Printed Article 2

Referring still to FIG. 1, the printed article 2 takes the form of a poster (e.g. mounted on a wall or other vertical or non-horizontal surface, or mounted or spread on a table top of other generally horizontal surface). The printed article 2 may be a point-of-sale display and may take the form of shelf edging, a dummy pack (i.e. an empty pack), a display pack, a display stack, a mobile, a poster or a banner.

The printed article 2 includes a sheet-like, opaque substrate 21 having first and second faces 22, 23. The substrate 21 can be formed from paper, card, plastic or other flexible or non-flexible material. A first (front) face 22 of the substrate 21 is provided with text, icons, graphic, images and/or other indicia 24. A second (reverse) face 23 of the substrate 21 is provided with conductive pads 25 which provide proximity-sensitive switches. The conductive pads 25 are connected to a controller 26 via conductive tracks 27. The controller 26 has an antenna 28 which can be provided on the second face 23 of the substrate 21. The controller 26 takes the form of a microcontroller.

The controller 26 and/or other components may be supported by and attached to (e.g. by soldering) to a printed circuit board (not shown) which is attached to the substrate 21, for example using conductive glue or tape. The controller 26 and/or other components may be directly attached to the substrate 21, for example using conductive glue or tape.

In some embodiments, two or more sheet-like substrates may be used. A first substrate (not shown) may support the indicia 24. If the first substrate is transparent, the indicia 24 can be formed on a reverse side. A protective layer (not shown) can be provided on the first substrate. A second substrate (not shown) can be used to support the conductive pads 25 and conductive tracks 27. A third substrate (not shown) can be interposed between the first and second substrates.

The conductive pads 25 and/or the conductive tracks 27 comprise conductive ink, for example silver-based conductive ink, and may be formed using a printing process, e.g. inkjet printing, gravure etc. onto the substrate 21. However, conductive pads 25 and/or conductive tracks 27 may comprise foil and may be formed by hot-foil stamping. The conductive tracks 27 typically have a resistance less than 100 kΩ.

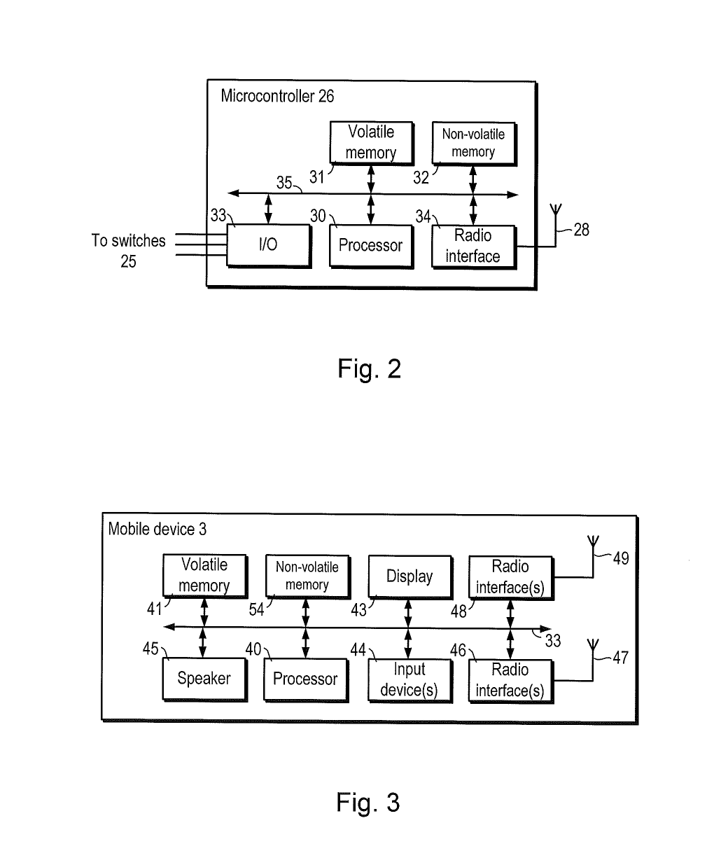

Referring also to FIG. 2, the microcontroller 26 comprises a processor 30, volatile memory 31, non-volatile memory 32 (e.g. Flash), an input/output module 33 and a radio interface module 34 connected by a bus system 35. Other modules and peripheral modules may be provided. Furthermore, a single microcontroller need not be used. For example, a separate capacitive sensing module and/or a separate radio interface module may be used. The radio interface module 35 conforms to Bluetooth®. The printed article 2 supports a battery, solar cell or other power source.

Referring also to FIG. 3, the mobile device 3 may take the form of a smart phone, tablet computer or other form of hand-held device having wireless connectivity. The mobile device 3 includes a processor 40, volatile memory 41, non-volatile memory 42, a display 43, input device(s) 44, a speaker 45, a first radio interface module 46 having a respective antenna 47 and a second radio interface module 48 having a respective antenna 48 connected by a bus system 49. A microphone (not shown), camera (not shown) and other devices or modules may be provided. The display 43 may take the form of a touch display and, thus, incorporate an input device.

The first radio interface module 46 provides Bluetooth, WiFi, or some other form of short-range wireless connectivity. Thus, the printed article 2 can communicate with the mobile device 3 via a wireless connection. The second radio interface module 48 provides mobile telecommunications connectivity (such as GSM, EDGE, 3G and/or 3G+ connectivity).

The routing node 4 can take the form of a wireless access node. The network(s) 18 may include a (wired or wireless) local area network and/or a wide area network. The network(s) 18 may include a plurality of connected networks.

The logging node 4 can take the form of a server (not shown) connected to a wireless access node (not shown).

The first server 16 can provide a mobile application 14 to the mobile device 3. The server 16 may locally store the application 14 or may fetch the application 14 from a remote server (not shown) and serve the application 14 to the mobile device 3.

The second server 17 can provide content 15, for example audio content, to the mobile device 3. The server 17 may locally store content 15 or may fetch a mobile application from a remote server (not shown) and serve the content to the mobile device 3.

The printed article 2 can be used can be used in a number of different ways.

For example, the printed article 2 can control the mobile device 3 and use the mobile device 3 as an agent for controlling, retrieving and/or rendering content, e.g. audio, to enhance the functionality of the printed article 2.

The printed article 2 may be used to record user preferences and forward data, for example, via the mobile device 3 or the logging node 5.

These and other ways of employing the printed article 2 will now be described in more detail.

Use of the Printed Article 2 to Control Retrieval and/or Rendering of Content

Referring to FIGS. 1 to 6, a method of using the printed article 2 to control the retrieval and/or rending of content using a mobile device 3 or node 4 or other similar forms of control will now be described.

A user in possession of the mobile device 3 may, when faced with the printed article 2, download a dedicated mobile application 14. The printed article 2 may display the name of the application 14 and/or provide details of or a link or code for downloading of the application 14. Thus, the mobile device 3 may download the mobile application 14 from the first server 16 (step S1). The mobile application 14 is started (step S2). The application need not be a dedicated mobile application, but can be a general-use application 14, such as a web browser, which may be pre-installed on the mobile device 3. In the case of a node 4, suitable software may already be installed.

The printed article 2 and a device 3, 4 establish a wireless connection 10 (step S3). In the case of a mobile device 3, in some embodiments, the printed article 2 and mobile device 3 establish a wireless connection 6 before the mobile device 3 downloads or starts the application 14.

The user may start interacting with the printed article 2, for example, by touching the printed article 2 and actuating one or more switches 25 (step S4).

The controller 26 interprets actuation of a switch 25, actuation of a combination of switches 25 or actuation of a sequence of switches 25, identifies a control message 50 and transmits one or more control messages 50 wirelessly to the mobile device 3 or node 4 (step S5).

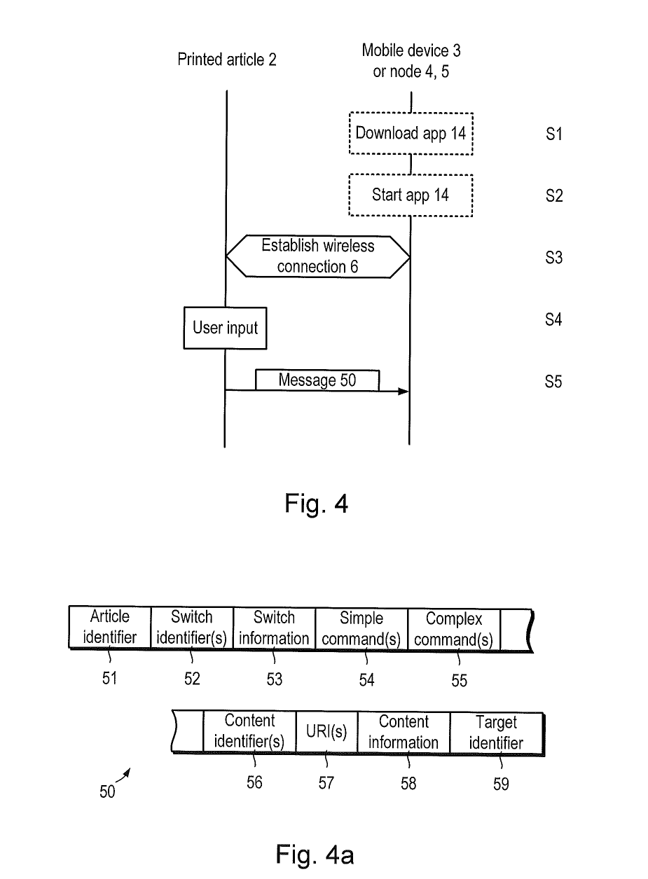

Referring in particular to FIG. 4a, the message 50 is described in more detail.

The message 50 may include one ore more parts 51, 52, 53, 54, 55, 56, 57, 58, 59.

The message(s) 50 may include an article identifier 51 identifying the article.

The message(s) 50 may include switch identifier (s) 52 identifying which switch 25 or switches 25 have been pressed. The message(s) 50 may include other switch-related information 53 for example, identifying an order in which the switches 25 have been pressed and/or time(s) at which the switches 25 were pressed.

The message(s) 50 may include simple command(s) 54, for example which may be used to control a cursor or focus in an application, and/or complex command(s) 55, for example in the form of a computer code, such as an applet or script.

The message(s) 50 may include identifier(s) 56 identifying content (e.g. audio content) and/or uniform resource identifier(s) 57 identifying a location at which content is stored and/or other content-related information 58.

The message(s) 50 may include target identifier(s) 59 for identifying destination(s) to which content, computer code and/or data is to be sent.

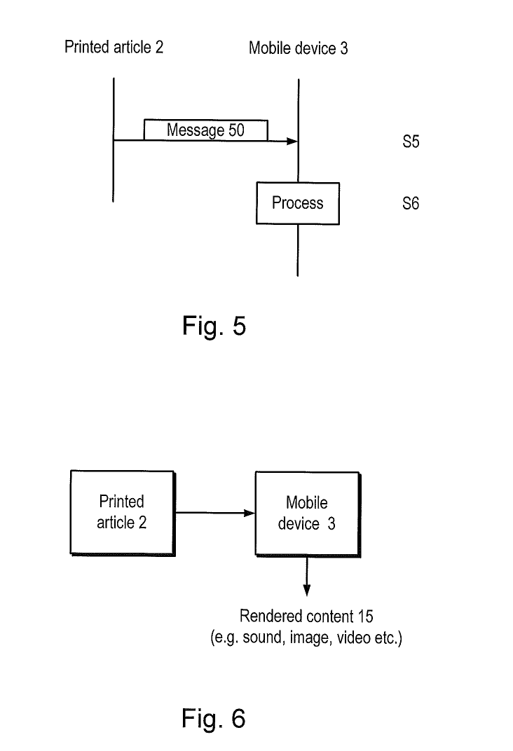

Referring in particular to FIGS. 5 and 6, the message(s) 50 is (are) passed to the mobile application 14 which executes any instructions contained in the message(s) 50 (step S6).

For example, the message(s) 50 may include a command 54 to render particular content 15 identified by the identifier 56. In this case, the content 15 is stored in the mobile device 3 and so the mobile device 3 can act upon the instruction and render the content 15.

This arrangement can be used, for example, to enhance the functionality of the printed article 2. For example, in a museum setting, a user can press a switch 25 on a poster 2 and the poster 2 can instruct the mobile device 3 to play music or pre-recorded commentary.

Additionally or alternatively, this can be used to record user selection and/or provide information which can be displayed. For example, in a shop setting, a user can press a switch 25 on a point-of-sale display 2. This can be used to identify an item which the user wishes to purchase and to display additional information, such as images of the item in use, stock availability etc.

In some examples, the mobile device 3 may need to retrieve content, an application and/or other data, as will now be described in more detail:

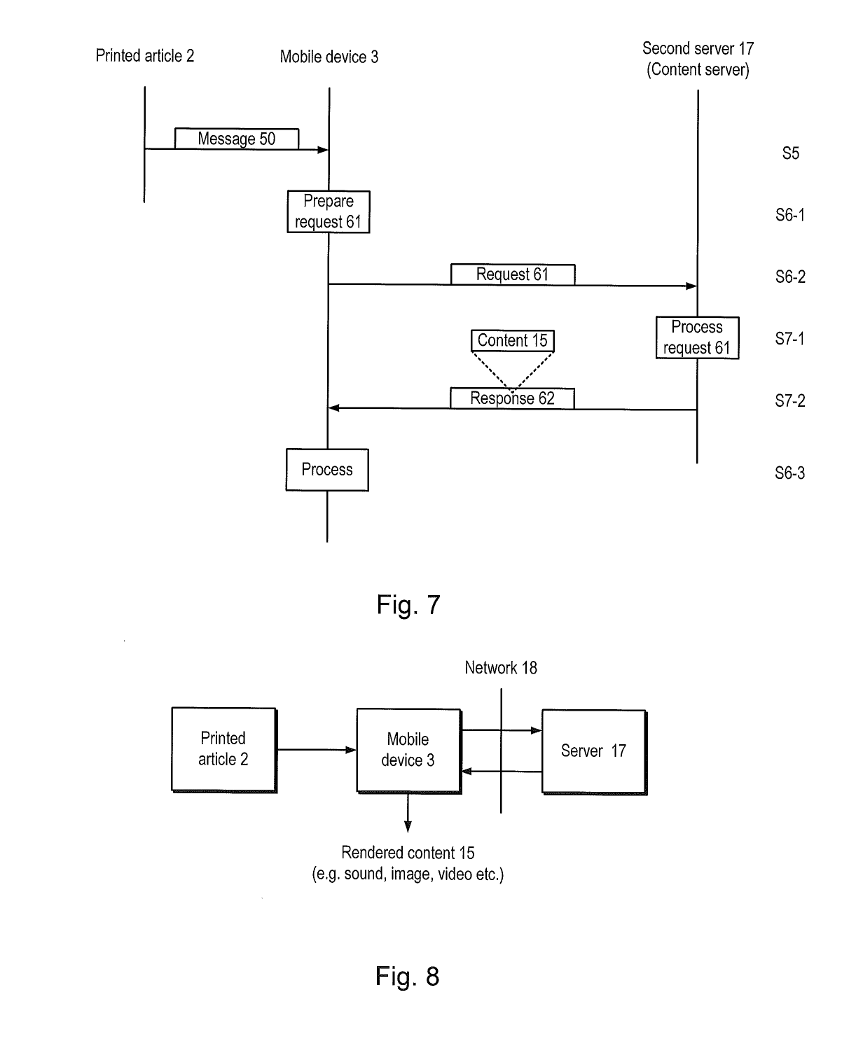

Referring in particular to FIGS. 7 and 8, the message(s) 50 is (are) passed to the mobile application 14 which executes any instructions contained in the message(s) 50 (step S6). However, in this case, the message 50 may instruct or require the mobile application 14 to download content 15. For example, the message 50 may include the name of the content and/or a uniform resource identifier (URI).

The controller 26 interprets actuation of a switch 25, actuation of a combination of switches 25 or actuation of a sequence of switches 25, prepares and transmits control message 50(s) wirelessly to the mobile device 3 (step S5). The message(s) 50 is (are) passed to the mobile application 14 which identifies that it requires content from, for example, the second server 17 and prepares a request 61 (step S6-1). The mobile device 3 transmits the request 61 to the second server 17 (step S6-2).

The server 17 processes the request 61 (step S7-1) and sends a response 62 which includes content 15 (step S7-2). The mobile application 14 renders the content 15 (step S6-3). In other examples, computer code or other data may be requested, instead of content.

In certain examples, the mobile device 3 or node 4 may retrieve content, an application and/or other data but, rather than use the retrieved resource itself, the mobile device 3 or node 4 may pass it on to a target, namely the printed article, as will now be described:

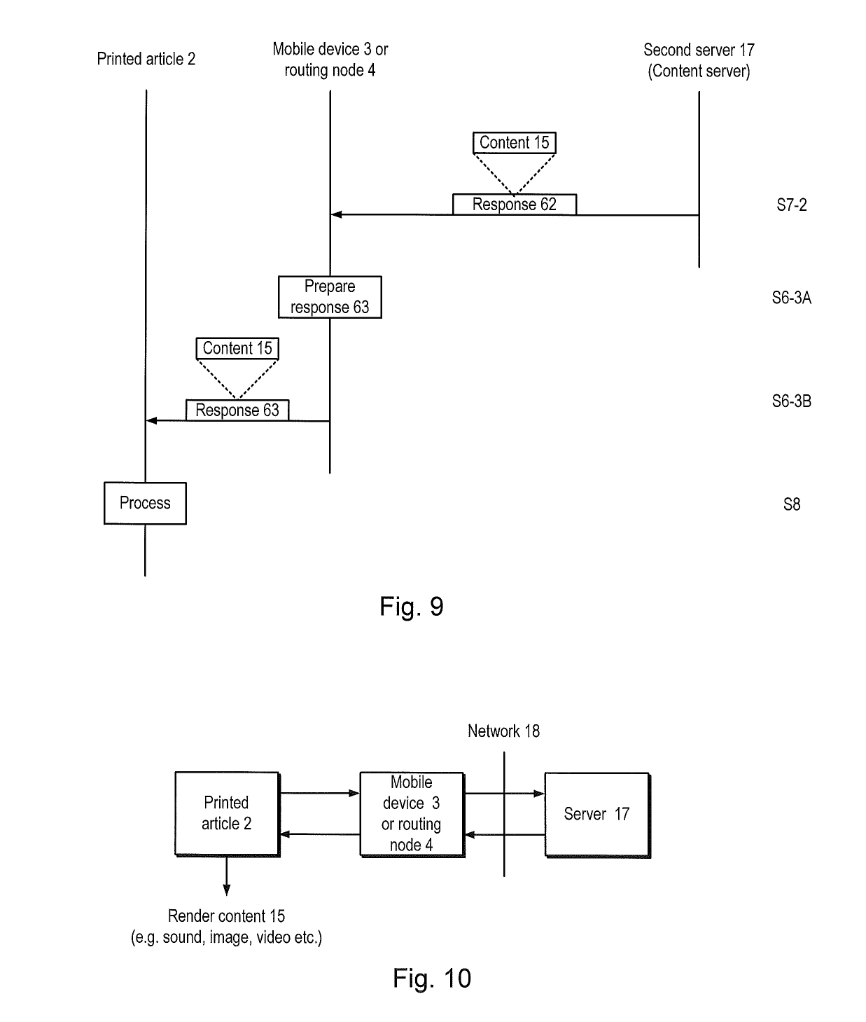

Referring still to FIG. 7 and referring also to FIGS. 9 and 10, the mobile device 3 receives a message 50 (step S5), prepares and sends a request 61 (step S6-1 & S6-2) and receives a response 62 (step S7-2) as described earlier.

However, instead of rendering the content 15, the mobile device 3 prepares a response 63 (step S6-3A) and transmits the response 63 to the printed article 2 (step S6-3B). The printed article 2 renders the content 15 (step S8).

In some examples, the mobile device 3 may already store the requested content 15 and so there may be no need to request the content from the server 17.

Furthermore, in certain examples, the user may be prompted to provide some input when preparing the response 63, for example, to choose between more than one set of content, to enter user-related information (e.g. name) or user choices (e.g. playback volume) etc.

In some examples, the routing node 4 may take the place of the mobile device 3, i.e. the user need not use a device in their possession.

This arrangement can be used, for example, to enhance functionality of the printed article 2 even further. For example, in a museum setting, a user can press a switch 25 on a poster 2 and the poster 2 can instruct the mobile device 3 or routing node 4 to provide it with music or pre-recorded commentary. Once it receives the content from the mobile device 3 or routing node 4, the poster 2 can play the music or commentary.

In some examples, the mobile device 3 or routing node 4 request content, computer code and/or other data and the server 17 may send the requested resource to a target directly, such as to another mobile device 3 or, in the case of a routing node 4, to a mobile device 3, as will now be described:

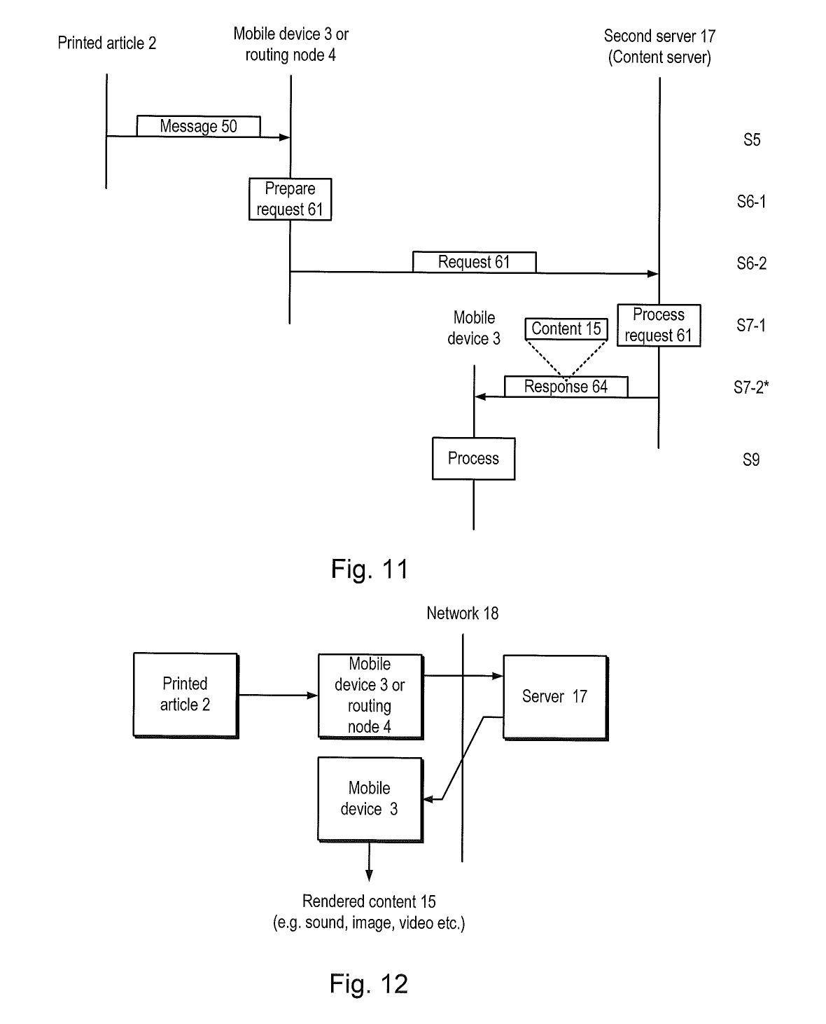

Referring still to FIG. 7 and referring also to FIGS. 11 and 12, the mobile device 3 receives a message 50 (step S5) and prepares and sends a request 61 to the server 17 (step S6-1 & S6-2).

The request 61 includes the identity of the target, for example, in the form of an IP address. Thus, the server 17 prepares and sends a response 64 (step S7-2*) to another device. The other device renders the content (step S9).

Interaction between the printed article 2 and the mobile device 3 (or routing node 4) can be terminated in any number of different ways. For example, the user may select to unpair the mobile device 3 and printed article 2. A connection may be dropped by ending the app.

The printed article 2 can be used to send successive sets of message(s) 50 which are handled in different ways. For example, a user may press switches on the same poster and cause content to be obtained from different sources and/or rendered at different targets. For example, a first time the user presses switches, the mobile device 3 may render content which is already stored in the mobile device 3. A second time the user presses switches, the same mobile device 3 may retrieve content from a remote source and then render it. A third time the user presses switches, the mobile device 3 may retrieve content from a remote source and then forward it to the printed article 2. Other permutations and combinations are possible.

Furthermore, the printed article 2 can be used to send successive sets of message(s) 50 to different mobile devices 3. For example, a first user can interact with a poster 2 and have content rendered on their mobile device 3 and a second, different user with a different mobile device 3 can subsequently interact with the poster 2 and have content rendered on their mobile device 3 or elsewhere.

Moreover, different printed articles 2 may be wireless connected to the same mobile device 3 simultaneously and/or successively. For example, the user can activate switches on different posters and content may be rendered on the same mobile device 3.

An arrangement in which the printed article 2 is employed to control the mobile device 3 (or routing node 4) and to use the mobile device 3 (or routing node 4) as an agent for rendering content to enhance the functionality of the printed article 2 can have one or more advantages.

The printed article 2 need not transmit the content 15, e.g. an audio clip, directly to mobile device 3. Expressed differently, the mobile device 3 does not receive, from the printed article 2, content for rendering. Instead, the printed article 2 can send an instruction which identifies the content 15 to the mobile device 3 and the mobile device 3 retrieve the content 15.

In this way, the mobile device 3 can independently retrieve content 15 via a high-bandwidth wireless connection and render the content 5. Thus, in some embodiment, the required content 15 need not be stored at or transmitted by the printed article 2. Therefore, in such embodiments, the controller 26 can be simplified and be provided with minimal processing power, memory and/or wireless connectivity and so help reduce the cost of the printed article 2.

Moreover, content 15 can be updated without needing to access the printed article 2. For example, old content (such as a segment of speech or other audio) can be updated with new content simply by updating the content 15 at the server 17 or other server (not shown). This can be done from a remote location.

Furthermore, content 15 can be provided in a wider range of formats, with different levels of compression, different levels of encryption, and/or different levels of digital right permission according to the capability of the device 3. Thus, the controller 26 need not store content in different formats, file size etc. Moreover, the mobile device 3 can obtain data from a trusted source. The use of protected content can also be controlled.

### Use of the Printed Article 2 for Information Logging

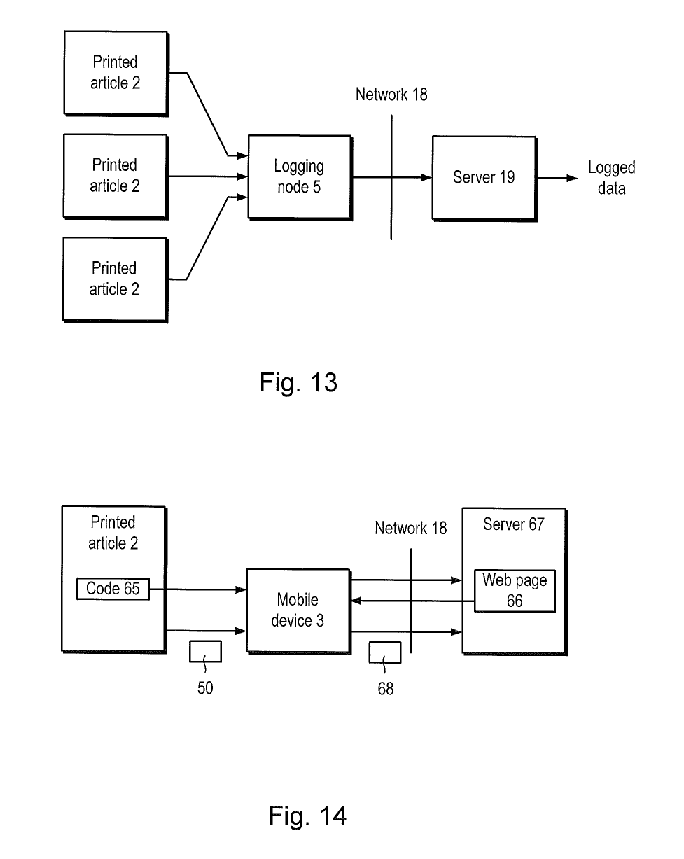

Referring to FIGS. 1, 4a and 13, a method of using the printed article 2 to record user preferences and to send data to a logging node 5 will now be described.

As explained earlier, a user can interact with the printed article 2, for example, by touching the printed article 2 and actuating one or more switches 25. The controller 26 interprets actuation of a switch 25, actuation of a combination of switches 25 or actuation of a sequence of switches 25 and transmits a suitable message 50.

In this example, the message 50 includes an article identifier 51, switch identifiers 52 and, optionally, switch information 53 which include timestamp(s). The message 50 is transmitted to a logging node 5 which stores the message 50 together with other messages from the same printed article 2 and/or other printed articles 2.

The messages 50 or data generated from the messages (such as statistics) are transmitted to the third server 19. The logging node 5 may transmit the messages or data on receipt of a message. Additionally or alternatively, the logging node 5 may store messages 50 and transmit the messages or data according to a schedule and/or on demand.

This arrangement can be used to gather information about user preferences. For example, the printed article 2 may be a point-of-sale display. The point-of-sale display 2 may invite the user to give their opinion or provide feedback about a product or service. Several point-of-sale displays 2 may be located in store which shares a logging node 5.

The point-of-sale display which is capable of receiving user input and transmit wirelessly can be easily and cheaply manufactured. Moreover, such displays can be easily installed.

More complex forms of information logging may be carried out.

Referring to FIG. 14, a code 65, for example, in the form of an alphanumeric code or Quick Response (QR) code, is presented on the printed article 2, i.e. printed on the substrate 21 (FIG. 1).

A user enters the code 65 into the mobile device 3 or the mobile device 3 reads the code 65, for example, using an in-built camera. The code 65 directs the mobile device 3 to access a web page 66 retrieved from a web server 67. The user presses one or more switches 25 and the controller 26 interprets actuation of the one ore more switches 25 and transmits a message 50. The message 50 may include an article identifier 51, switch identifiers 52 and, optionally, switch information 53 which include timestamp(s).

The mobile device 3, in turn, transmits a message 68 to the logging server 19 or web server 67. The message 68 may include information contained in the message 50 from the printed article 2 and/or information contained in code 65. The mobile device 2 may invite the user to add additional information (such as name and other personal details) and/or to request permission send information stored on the device 2 (such as IP address) to the server 19, 67.

This arrangement can be used to gather information about user preferences. For example, the printed article 2 may be a poster which may offer a discount. Thus, the user can use the code 65 to go to a website and use the poster to provide user input. User input via the poster 2 can add interest, may provide additional useful information (such as detailed location) and/or may allow user input which may be difficult to provide via a mobile device 3 with a small form factor.

In the embodiments described earlier, the controller 16 and/or other components may be attached to the substrate, for example using conductive glue or tape.

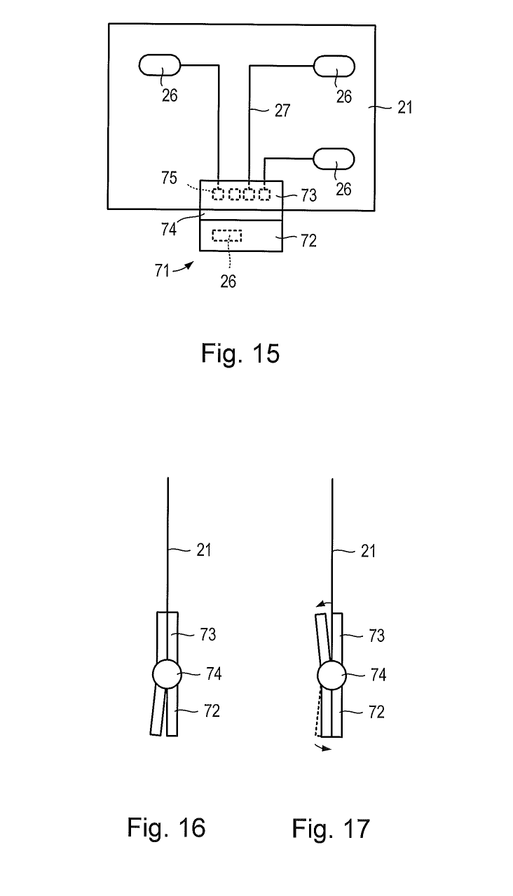

Referring to FIGS. 15 to 17, the controller 16 and/or other components (not shown) may be housed in a separate unit 71 which may be attached to the printed article 2 by clipping the unit 71 to the substrate 21 (which supports the switches 26). The other components may include a speaker and/or light emitting diodes.

In this example, the unit 71 comprises a pair of handles 72 and opposing clamping members 73 attached via a hinge 74. The unit 71 includes a spring or other biasing mechanism (not shown) which urges the clamping members 73 inwardly together. However, the clamping members 73 can be separated by pressing the handles 72 together.

Electrical contact pads (not shown) are arranged on an inner-facing surface (not shown) of one or both of the clamping members 73. The electrical contact pads are spaced so as to connect to corresponding pads 75 on the substrate 21. The electrical contact pads (not shown) are connected to the controller 26 and/or other components (not shown).

FIG. 16 shows the unit 71 clamped to the substrate 21. FIG. 17 shows the unit 71 when a user presses on opposing outer surfaces of e the handles 72 so as to cause the clamping members 73 to move apart to allow the unit 71 to positioned ready for clamping or to be unclamped from the substrate 21.

The unit can take different shapes and be different sizes. The unit can clamp onto the substrate using other, different mechanisms.

Using this arrangement, the controller 26 and other components can be removably attached to a printed article 2. This can help facilitate assembly and can allow more costly components to be re-used or temporarily attached.

Examples of Using a Printed Article 2 to Control Retrieval and/or Rendering of Content

As explained earlier, a printed article 2, such as a poster, can be use to control retrieval and/or rending of content. Examples of using a printed article 2 will now be described in more detail.

Referring to FIG. 1, the printed article 2 may take the form of a poster in a fast-food restaurant or other food or retail outlet. The poster advertises a special offer for a meal. A user enters the restaurant and sees the poster. The user has a mobile device 3, for example in the form of a smart phone, running a controller application 14.

Referring to also to FIG. 7, the user decides that they like the special offer and wish to purchase the meal. The user touches the poster 2 thereby activating a proximity-sensitive switch 25. This causes the poster 2 transmits a message 50 to the mobile device 3. The message may include a name and media access control (MAC) address or other information for enabling the poster 2 and mobile device 3 to pair. The mobile device 3 may be arranged to pair with a poster 2 automatically (i.e. without any user input).

Using the message 50, for example using the name or a URI included in the message 50, the mobile device 3 sends a request 61 to a server, e.g. the server 17, and downloads instructions 15 for interpreting signals transmitted by the poster 2 in response to the user actuating switches 25.

The user touches a particular part of the poster 2 (for example, a picture of the meal on offer) to select the meal. The poster 2 then transmits a signal to a terminal (not shown) in the restaurant which informs staff that an order has been placed for that meal.

The user may hand over a payment (e.g. cash or card) or use a cashless payment system (for example employing the mobile device 2 and near-field communication) to pay for the meal. Alternatively, the user may configure their mobile device 2 to allow the restaurant to take or at least initiate a process of taking a payment. For example, the mobile device 2 may send payment information to the poster 2 which in turn forwards the payment information to the terminal (not shown) or a separate point-of-sale (POS) terminal (not shown) to initiate electronic payment. The mobile device 2 may send payment information to the terminal, e.g. directly or via the mobile network. For example, the payment information may include an account name and/or account details which allow the terminal to compete a first set of steps of a transaction. The transaction may be completed, for example, by the user entering a personal identification number (PIN).

The printed article 2 may take the form of an advertisement poster. The poster may advertise a music album or artist, game, movie or any other form of content.

The user decides that they would like to listen to some music. The user touches the poster 2 thereby activating a proximity-sensitive switch 25. In a similar way to that described earlier, activating a proximity-sensitive switch 25 causes the poster 2 to transmit a message 50 to the mobile device 3. The message may include a name and media access control (MAC) address or other information for enabling the poster 2 and mobile device 3 to pair. The mobile device 3 may be arranged to pair with a poster 2 automatically (i.e. without any user input).

Using the message 50, for example using the name or a URI included in the message 50, the mobile device 3 sends a request 61 to the server 17 and downloads instructions 15 for interpreting signals transmitted by the poster 2 in response to the user actuating switches 25.

The user touches a particular part of the poster 2 (for example, a name of a track) to select the track. The poster 2 then transmits a signal to mobile device 3. The signal 3 includes a link which allows the application 14 to download and play a clip of music.

The user can touch a particular part of the poster 2 to buy the track or album. The poster 2 sends a link to the server 17 (or another server) to download the music and receive payment.

In the processes just described, the user need not directly or contemporaneously use the mobile device 3. For example, the mobile device 3 may sit in a pocket or bag and not be handled by the user during the process.

Thus, a consumer (i.e. the user) and the provider may exchange data and information (such as one or more selection(s), one or more instruction(s), one or more pieces of information and/or one or more confirmation(s)) and effect an action and/or transaction using the printed article 2 and the mobile device 3. Data and information may simply pass through the mobile device 3 without the user using the mobile device 3.

The application 14 may be a general purpose application which can be used with different printed articles 2 in different settings and for different uses. As explained earlier, the mobile device 3 can receive a name and/or other information from a printed article 3 and can automatically download from the application server 16 or content server 17 any necessary information (which can be simply referred to as “settings”) needed to interpret signals transmitted by the printed article 2 in response to keystrokes. However, the user can manually enable or select settings (for example, they may be transmitted by a printed article 2 or be one of a number of pre-loaded settings). The user can also transmit and store settings for private use or public use in a central server 16, 17. The server 16, 17 can store the settings together with a name. Thus, any user when presented with a printed article 2 can obtain a name (e.g. by the printed article transmitting the name) and can search for and retrieve settings from the central server 16, 17 using the name.

For example, the printed article 2 (a “printed piano”) may show a piano keyboard with a switch associated with each key. Thus, when the user presses any key for the first time (or after a period of inactivity), the printed piano 2 transmits an initial message, for example, including the name “Piano”. Thereafter (or for at least a given period of time thereafter), when the user presses a key, the printed piano 2 transmits a message including a switch identifier which identifies the key being pressed. Using the initial message, the mobile device 3 can retrieve settings for “Piano” from a server 16, 17. Once the mobile device 3 has these setting, it can interpret different switch identifier and play a (piano-sounding) note corresponding to the key being pressed.

Another printed article 2 (a “printed flute”) may show a flute with a switch associated with each hole. By a similar process and using the same application 14, the user can pair their device with printed flute 2, retrieve settings and then play the printed flute.

### Modifications

It will be appreciated that many modifications may be made to the embodiments hereinbefore described.

For example, the printed article need not take the form of a poster or point-of-sale display, but can be a book or board game.

The wireless connection between the printed article and the mobile device need not be a radio connection, but can be, for example, an optical link or sound.

The controller and/or other components, such as a speaker, may be supported on separate substrate or frame.

The printed article may include or be connected to a camera or other (still or moving) image capturing device. The image capturing device may be connected to the controller and the controller may transmit image data.

The printed article may include or be connected to a temperature sensor. The temperature sensor may be connected to the controller and the controller may transmit temperature data.

The printed article may include or be connected to a positioning (or “locating”) device (e.g. a GPS device) for determining the location of the printed article. The positioning device may be connected to the controller and the controller may transmit position data.

The printed article may additionally or alternatively include one or more touch- or proximity-sensitive array for providing array user input, e.g. x-y coordinates. The array may be connected to the controller and the controller may transmit array input data.

The printed article may be configured to communicate with another printed article. The printed articles may be configured to communicate directly via a wireless communication link. The printed articles may be configured to communicate directly via a network, e.g. network 18.

1. A printed article comprising:
a substrate;
a touch- or proximity-sensitive switch supported on the substrate;
a processor configured to generate, in dependence upon actuation of the switch, a message; and
a wireless interface configured to transmit the message wirelessly.

2. A printed article according to claim 1, wherein the switch comprises conductive ink.

3. A printed article according to claim 1, wherein the switch comprises conductive foil.

4. A printed article according to claim 1, comprising at least two touch- or proximity-sensitive switches.

5. A printed article according to claim 1, wherein the substrate comprises paper or card.

6. A printed article according to claim 1, wherein the substrate comprises plastic.

7. A printed article according to claim 1, wherein the wireless interface is compatible with Bluetooth.

8. A printed article according to claim 1, wherein the wireless interface is compatible with IEEE 802.11.

9. A printed article according to claim 1, wherein the printed article comprises a poster.

10. A printed article according to claim 1, wherein the printed article comprises a point-of-sale display.

11. A printed article according to claim 1, wherein the message controls a mobile application.

12. A printed article according to claim 1, wherein the message controls a web browser.

13. A printed article according to claim 1, wherein the message includes an article identifier identifying the article.

14. A printed article according to claim 1, wherein the message includes at least one switch identifier, each switch identifier identifying a respective actuated switch.

15. A printed article according to claim 1, wherein the message includes information about an order in which one or more switches are actuated.

16. A printed article according to claim 1, wherein the message includes at least one command.

17. A printed article according to claim 1, wherein the message includes at least one complex command comprising multiple commands and/or computer code.

18. A printed article according to claim 1, wherein the message includes at least one content identifier, each content identifier indentifying respective content.

19. A printed article according to claim 1, wherein the message includes at least one universal resource identifier.

20. A printed article according to claim 1, wherein the message includes information about content.

21. A printed article according to claim 1, wherein the message includes a target identifier.

22. A printed article according to claim 1, further comprising a code which is visible to a user.

23. A system comprising:
a printed article according to claim 1;
a device in wireless communication with the printed article.

24. A system according to claim 23, wherein the device is a mobile device.

25. A system according to claim 23, wherein the device is configured to run a program which is controllable by a user operating the printed article.

26. A system according to claim 23, wherein the device is configured, in response to receiving a message from the printed article, to retrieve or send data to or from an external source.

27. A system according to claim 23, further comprising:
a server for providing content to the device.

28. A system according to claim 23, further comprising:
at least one other device in wireless communication with the printed article.

29. A method, in a printed article which comprises a substrate, a touch- or proximity-sensitive switch supported on the substrate, a processor for generating a message and a wireless interface for wirelessly transmitting the message wirelessly, the method comprising:
generating, in dependence upon actuation of the switch, the message; and
transmitting the message wirelessly.
